(19) United States
(12) Patent Application Publication
(10) Pub. No.: US 2016/0277061 A1
(43) Pub. Date: Sep. 22, 2016

(54) FRONT END MODULE AND WIRELESS COMMUNICATIONS APPARATUS USING THE SAME

(71) Applicant: Samsung Electro-Mechanics Co., Ltd., Suwon-si (KR)

(72) Inventors: Hyun Jeong SONG, Suwon-si (KR); Hyo Sun CHOI, Suwon-si (KR)

(73) Assignee: Samsung Electro-Mechanics Co., Ltd., Suwon-si (KR)

(21) Appl. No.: 14/995,951

(22) Filed: Jan. 14, 2016

(30) Foreign Application Priority Data
Mar. 17, 2015 (KR) 10-2015-0036803

(51) Int. Cl. H04B 1/48; H04W 4/00

(52) U.S. Cl. CPC H04B 1/48; H04W 4/008

(57) ABSTRACT

A front end module includes: a control integrated circuit configured to output at least one of a first transmission signal according to a first wireless communications standard and a second transmission signal according to a second wireless communications standard; a first switch configured to receive the at least one of the first transmission signal and the second transmission signal and output the first transmission signal or the second transmission signal in response to a control signal transmitted from the control integrated circuit; and a transmission amplifier configured to amplify the first transmission signal or the second transmission signal output from the first switch.

### CROSS-REFERENCE TO RELATED APPLICATION(S)

This application claims the benefit of Korean Patent Application No. 10-2015-0036803 filed on Mar. 17, 2015 in the Korean Intellectual Property Office, the entire disclosure of which is incorporated herein by reference.

### BACKGROUND

1. Field

The following description relates to a front end module and a wireless communications apparatus using the same.

2. Description of Related Art

In accordance with the development of wireless technology, various electronic devices have supported wireless communications. In particular, a single electronic device supporting a plurality of wireless communications functions has been demanded. In order to support the plurality of wireless communications functions as described above, a front end module configured to support the plurality of wireless communications functions has further been demanded.

In the related art, front end modules provide transmission signals to an antenna through separate paths in order to transmit different communications signals. In addition, in a case in which the transmission signals need to be amplified, the front end module needs to include a plurality of amplifiers respectively disposed on a plurality of paths through which the respective transmission signals are transferred. Therefore, a size of the front end module has increased, which is incongruous with a demand for miniaturization of the electronic devices.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a front end module includes: a control integrated circuit configured to output at least one of a first transmission signal according to a first wireless communications standard and a second transmission signal according to a second wireless communications standard; a first switch configured to receive the at least one of the first transmission signal and the second transmission signal and output the first transmission signal or the second transmission signal in response to a control signal transmitted from the control integrated circuit; and a transmission amplifier configured to amplify the first transmission signal or the second transmission signal output from the first switch.

The front end module may further include a second switch configured to be switched, in response to the control signal, to connect an output terminal of the transmission amplifier and an antenna to each other or connect the antenna and the control integrated circuit to each other.

The control integrated circuit may be configured to output the control signal including a plurality of pulses, and the first switch may be configured to be switched in response to a portion of the plurality of pulses of the control signal.

The front end module may further include a reception amplifier connected to the second switch and configured to amplify reception signals.

The control integrated circuit may be configured to output the control signal including four pulses, and the first switch may be configured to be switched in response to first and second pulses of the four pulses of the control signal.

The second switch may be configured to be switched in response to the four pulses of the control signal.

The second switch may be configured to be switched in response to first to third pulses of the four pulses of the control signal.

The reception amplifier may be configured to amplify the reception signals in response to a fourth pulse of the four pulses of the control signal.

The second switch may be configured to be switched to connect the output terminal of the transmission amplifier and the antenna to each other in response to one of the first and second pulses being high.

The second switch may be configured to be switched to connect the antenna and the control integrated circuit to each other in response to both of the first and second pulses being low and a third pulse of the four pulses of the control signal being high.

The second switch may be configured to be switched to connect the reception amplifier and the antenna to each other in response to both of the first and second pulses being low and a fourth pulse of the four pulses of the control signal being high.

The second switch may include a single-pole double-throw switch including two first terminals respectively connected to the control integrated circuit and the transmission amplifier, and one second terminal connected to the reception amplifier.

The reception amplifier may be configured to receive a portion of the control signal and amplify the reception signals in response to the portion of the control signal.

The second switch may include a double-pole double-throw switch including two first terminals respectively connected to the control integrated circuit and the transmission amplifier, and two second terminals respectively connected to the reception amplifier and the antenna.

The reception amplifier may be configured to amplify the reception signals when a path is formed by the second switch, without receiving the control signal.

The first wireless communications standard may be a Bluetooth scheme and the second wireless communications standard may be a wireless local area network scheme.

According to another general aspect, a wireless communications apparatus includes a front end module including: a control integrated circuit configured to output at least one of a first transmission signal according to a first wireless communications standard and a second transmission signal according to a second wireless communications standard; a first switch configured to receive the at least one of the first transmission signal and the second transmission signal and output the first transmission signal or the second transmission signal in response to a control signal transmitted from the control integrated circuit; and a transmission amplifier configured to amplify the first transmission signal or the second transmission signal output from the first switch.

The first wireless communications standard may be a Bluetooth scheme and the second wireless communications standard may be a wireless local area network scheme.

Other features and aspects will be apparent from the following detailed description, the drawings, and the claims.

### BRIEF DESCRIPTION OF THE DRAWINGS

FIG. 1 is a block diagram illustrating a front end module according to an embodiment.

FIG. 2 is a circuit diagram illustrating the front end module according to an embodiment.

FIGS. 3 through 5 are views for describing an operation of the front end module of FIG. 2.

FIG. 6 is a circuit diagram illustrating a front end module according to another embodiment.

FIGS. 7 through 9 are views for describing an operation of the front end module of FIG. 6.

FIG. 10 is a circuit diagram illustrating a front end module according to another embodiment.

FIGS. 11 through 14 are views for describing an operation of the front end module of FIG. 10.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

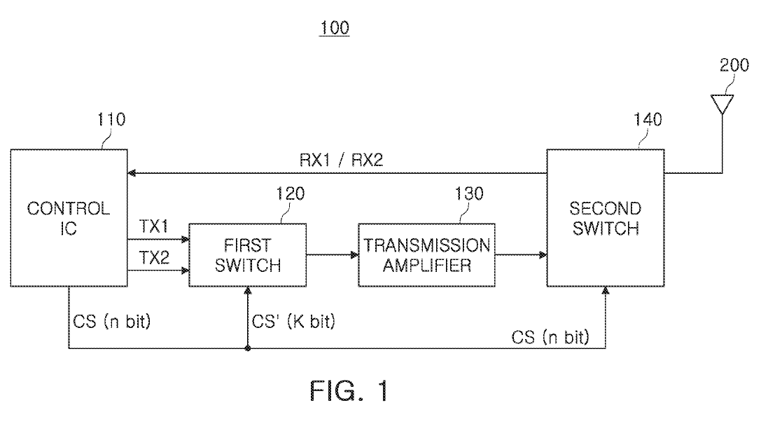

FIG. 1 is a block diagram illustrating a front end module 100 according to an embodiment.

Referring to FIG. 1, the front end module 100 includes a control integrated circuit 110, a first switch 120, and a transmission amplifier 130. The front end module 100 further includes a second switch 140.

The control integrated circuit 110 outputs transmission signals TX1 and TX2 according to wireless communications standards, or processes reception signals received in an antenna 200.

The control integrated circuit 110 outputs at least one of a first transmission signal TX1 according to a first wireless communications standard and a second transmission signal TX2 according to a second wireless communications standard. For example, the control integrated circuit 110 may output the first transmission signal TX1 according to a Bluetooth scheme and the second transmission signal TX2 according to a wireless local area network (LAN) scheme.

The control integrated circuit 110 receives and processes a first reception signal RX1 according to the first wireless communications standard or a second reception signal RX2 according to the second wireless communications standard.

The control integrated circuit 110 generates different control signals depending on whether signals are transmitted or received and a kind of target transmission signals to be transmitted, and transmits these control signals to the first and second switches 120 and 140. In an embodiment, a control signal CS includes a plurality of pulses. The control signal CS may be represented by a binary number value having a plurality of (n) bits at a specific point in time depending on values of the plurality of pulses.

The control integrated circuit 110 may be implemented by a central processing unit (CPU), a graphic processing unit (GPU), a microprocessor, an application specific integrated circuit (ASIC), a field programmable gate array (FPGA), or the like, and may have a plurality of cores. According to embodiments, the control integrated circuit 110 may include a memory therein or be operated using a memory separately provided at an outer portion thereof. The memory may be a volatile memory (for example, random access memory (RAM), or the like), a non-volatile memory (for example, read only memory (ROM), a flash memory, or the like), or a combination thereof.

The first and second transmission signals TX1 and TX2 are input to the first switch 120 through separate paths. The first switch receives at least one of the first and second transmission signals TX1 and TX2 through the separate paths. The first switch 120 is switched in response to the control signal CS transmitted from the control integrated circuit 110 to output one of the first and second transmission signals TX1 and TX2.

In an embodiment, the first switch 120 receives only a portion CS′ of the pulses in the control signal CS transmitted from the control integrated circuit 110 and is switched in response to the received pulses. As illustrated in FIG. 1, in a case in which the control integrated circuit 110 transmits the control signal CS configured of n bits, the first switch 120 receives only k bits CS′, which are portions of the n bits, and is switched depending on the k bits.

The transmission amplifier 130 is connected in series to an output terminal of the first switch 120. The transmission amplifier 130 amplifies a transmission signal, such as the first transmission signal TX1 or the second transmission signal TX2, output from the first switch 120.

The second switch 140 is switched to connect an output terminal of the transmission amplifier 130 and the antenna 200 to each other or to connect the antenna 200 and the control integrated circuit 110 to each other in response to the control signal. In an embodiment, the second switch 140 is operated using the entire control signal CS transmitted from the control integrated circuit 110. As illustrated in FIG. 1, in a case in which the control integrated circuit 110 transmits the control signal CS configured of n bits, the second switch 140 receives all of the n bits and is switched depending on the n bits.

As illustrated in FIG. 1, in an embodiment, a plurality of transmission signals TX1 and TX2 may be transmitted using only one amplifier. That is, the front end module 100 controls switching of the first switch 120 to output one of the first and second transmission signals TX1 and TX2 in response to a target signal to be transmitted and includes the transmission amplifier 130 disposed behind the first switch 120, whereby the plurality of transmission signals TX1 and TX2 may be transmitted using one amplifier. Therefore, since the front end module 100 uses only one transmission amplifier, the front end module 100 may be miniaturized.

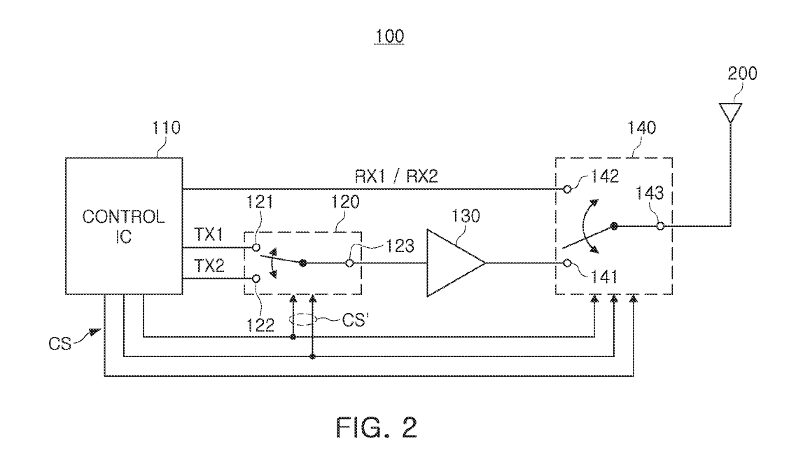

Hereinafter, various embodiments will be described with reference to FIGS. 2 through 14. However, contents that are the same as or correspond to the contents described above with reference to FIG. 1 among contents of the following embodiments may be understood from the description provided with reference to FIG. 1.

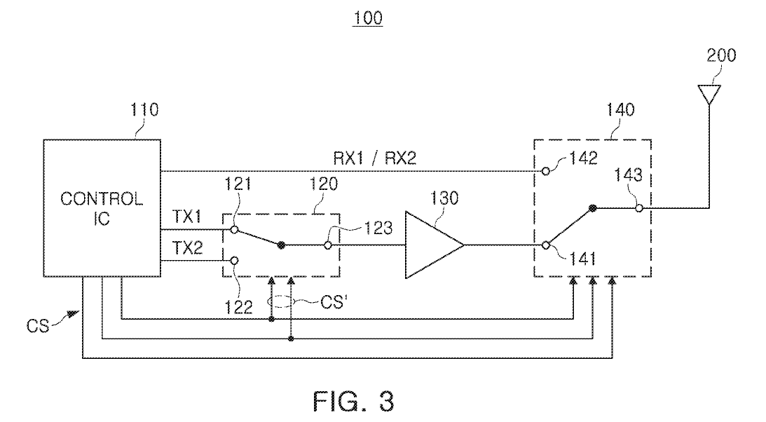

FIG. 2 is a circuit diagram illustrating the front end module 100 and FIGS. 3 through 5 are views for describing an operation of the front end module 100.

First, referring to FIG. 2, the first switch 120 is a single-pole double-throw (SPDT) switch switched in response to a portion CS′ of the control signal CS transmitted from the control integrated circuit 110 to output one transmission signal. The first switch 120 includes two input terminals 121 and 122 each connected to the control integrated circuit 110 and one output terminal 123 connected to the transmission amplifier 130.

The second switch 140 is a single-pole double-throw (SPDT) switch that provides the first or second transmission signal TX1 or TX2 to the antenna 200 or provides the first or second reception signal RX1 or RX2 received in the antenna 200 to the control integrated circuit 110. The second switch 140 includes one first terminal 141 connected to the transmission amplifier 130, another first terminal 142 connected to the control integrated circuit 110, and one second terminal 143 connected to the reception amplifier 150. An output of the transmission amplifier 130 is input to the terminal 141 of the second switch 140. An input received from the antenna 200 is input to the control integrated circuit 110 from the terminal 142.

The control integrated circuit 110 generates the control signal CS and transmits the control signal CS to the first and second switches 120 and 140. In an example illustrated in FIG. 2, the control signal CS is a voltage signal including three pulses transferred through three paths. In addition, the first switch 120 receives only a portion CS′, for example, two of a plurality of pulses included in the control signal CS and is switched in response to the received pulses.

Table 1 is a table illustrating values of the control signal CS that is used in the example illustrated in FIG. 2. The example control signal CS of Table 1 and FIG. 2 supports a Bluetooth (BT) scheme and a wireless local area network (WL) scheme.

TABLE 1

| | Control Signal | | |
|---|---|---|---|
| RF mode | WL_TX | BT_TX | RX |
| WL Transmission Mode | 1 | 0 | 0 |
| BT Transmission Mode | 0 | 1 | 0 |
| Reception Mode | 0 | 0 | 1 |

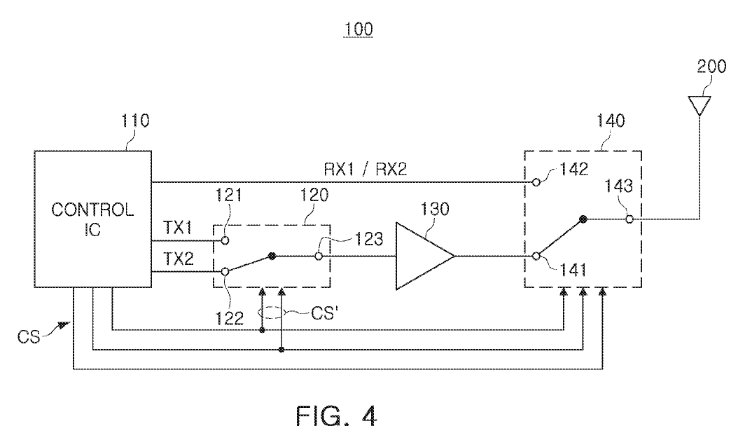

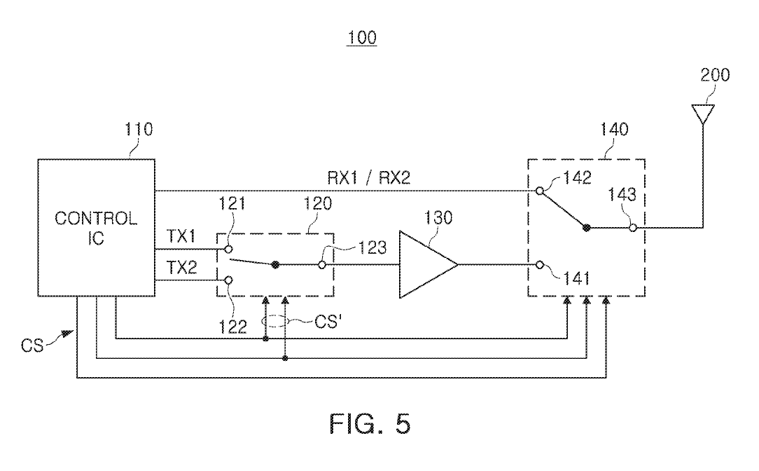

Referring to Table 1, FIG. 3 illustrates the control signal CS in a case in which an RF mode is a WL transmission mode, FIG. 4 illustrates the control signal CS in a case in which an RF mode is a BT transmission mode, and FIG. 5 illustrates the control signal CS in a case in which an RF mode is a reception mode.

In examples illustrated in FIGS. 3 and 4, since the RF mode is a transmission mode, the first switch 120 is switched depending on two pulse values of the control signal to output one of WL_TX and BT_TX, and the second switch 140 is switched to connect the transmission amplifier 130 and the antenna 200 to each other so that the transmission signal TX1 or TX2 is transferred to the antenna 200.

Meanwhile, in an example illustrated in FIG. 5, since the RF mode is the reception mode, the second switch 200 is switched to connect the antenna 200 and the control integrated circuit 110 to each other, and the first or second reception signal RX1 or RX2 received in the antenna 200 is transferred to the control integrated circuit 110.

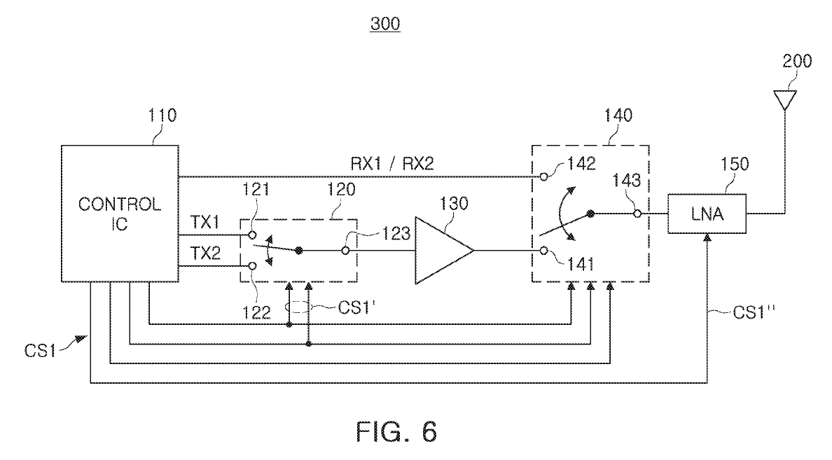

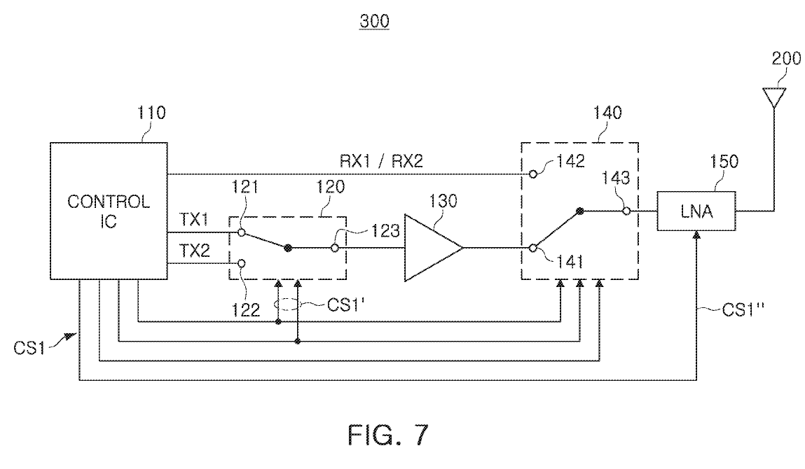

FIG. 6 is a circuit diagram illustrating a front end module 300 according to another embodiment, and FIGS. 7 through 9 are views for describing an operation of the front end module 300.

Referring to FIG. 6, the front end module 300 includes the control integrated circuit 110, the first switch 120, the transmission amplifier 130, the second switch 140, and a reception amplifier 150.

The reception amplifier 150 is connected to the second switch 140 and amplifies reception signals. In FIG. 6, an example in which a low noise amplifier (LNA) is used as the reception amplifier 150 is illustrated. That is, in the front end module 300, the reception signal RX1 or RX2 is amplified or bypassed (e.g., passed through without being amplified) at the reception amplifier 150, and processed in the control integrated circuit 110.

Table 2 is a table illustrating values of a control signal CS1 that is used in an example illustrated in FIG. 6. The control signal CS1 includes four pulses, and values of respective pulses may be defined as illustrated in Table 2.

TABLE 2

| | | Control Signal | | | |
|---|---|---|---|---|---|
| RF mode | | WL_TX | BT_TX | RX | LNA_ON |
| WL Transmission Mode | | 1 | 0 | 0 | 0 |
| BT Transmission Mode | | 0 | 1 | 0 | 0 |
| Reception | Bypass | 0 | 0 | 1 | 0 |
| Mode | Reception | 0 | 0 | 1 | 1 |
| | Amplification | | | | |

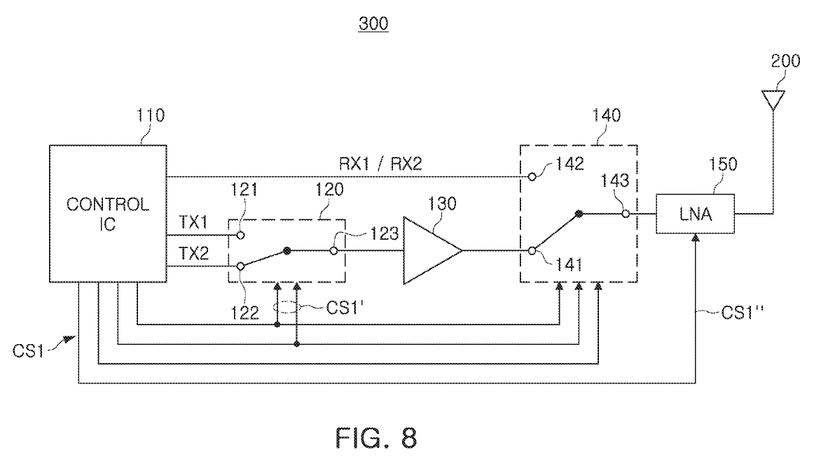

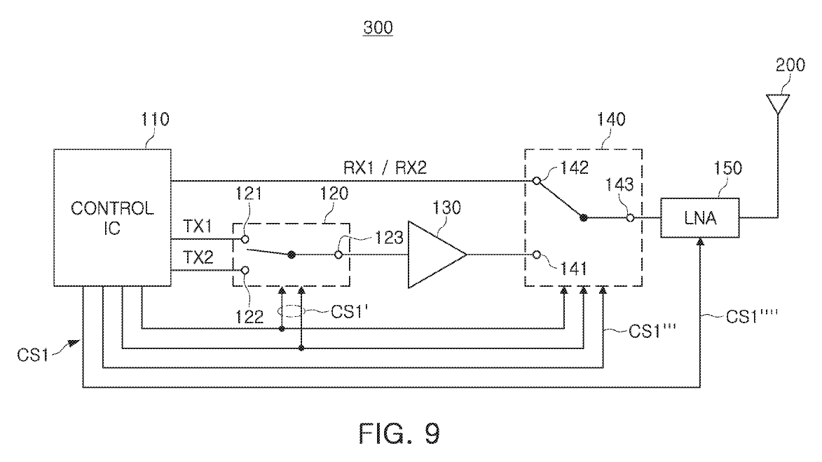

FIG. 7 illustrates an example of a WL transmission mode, FIG. 8 illustrates an example of a BT transmission mode, and FIG. 9 illustrates a reception mode.

The first switch 120 is switched in response to a portion CS1′ of the control signal CS1, that is, first and second pulses of four pulses of the control signal CS1 in the illustrated example.

The first terminals 141 and 142 of the second switch 140 are connected to the transmission amplifier 130 and the control integrated circuit 110, respectively, and the second terminal 143 is connected to the reception amplifier 150.

The second switch 140 is switched in response to first to third pulses of the four pulses of the control signal.

In an embodiment, the second switch 140 is switched to connect the output terminal of the transmission amplifier 130 and the antenna 200 to each other when one of the first and second pulses CS1′ of the four pulses of the control signal CS1 is high.

In an embodiment, the second switch 140 is switched to connect the antenna 200 and the control integrated circuit 110 to each other when both of the first and second pulses CS1′ of the four pulses of the control signal CS1 are low and a third pulse CS1′″ of the four pulses of the control signal CS1 is high.

The reception amplifier 150 is operated in response to the control signal CS1. In an embodiment, the reception amplifier 150 receives a portion of the control signal CS1 and amplifies the reception signals RX1 and RX2 in response to a portion CS1″″ of the control signal CS1. For example, the reception amplifier 150 performs an amplifying operation in response to a fourth pulse CS1″″ of the four pulses of the control signal CS1. Since the reception amplifier 150 is present on a path through which the reception signals RX1 and RX2 are transmitted, the reception amplifier 150 may not be operated in the transmission mode.

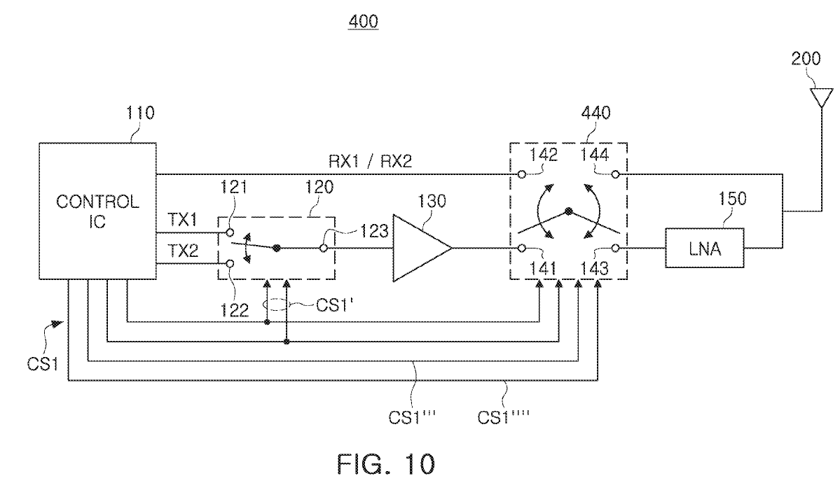

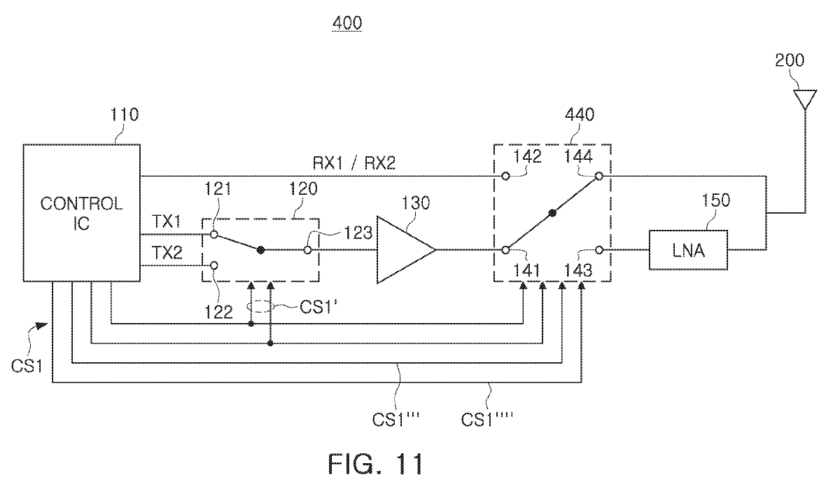

FIG. 10 is a circuit diagram illustrating a front end module 400 according to another embodiment, and FIGS. 11 through 14 are views for describing an operation of the front end module 400.

Referring to FIGS. 10 through 14, the reception amplifier 150 amplifies the reception signals RX1 and RX2 when a path is formed by a second switch 440, without receiving the control signal.

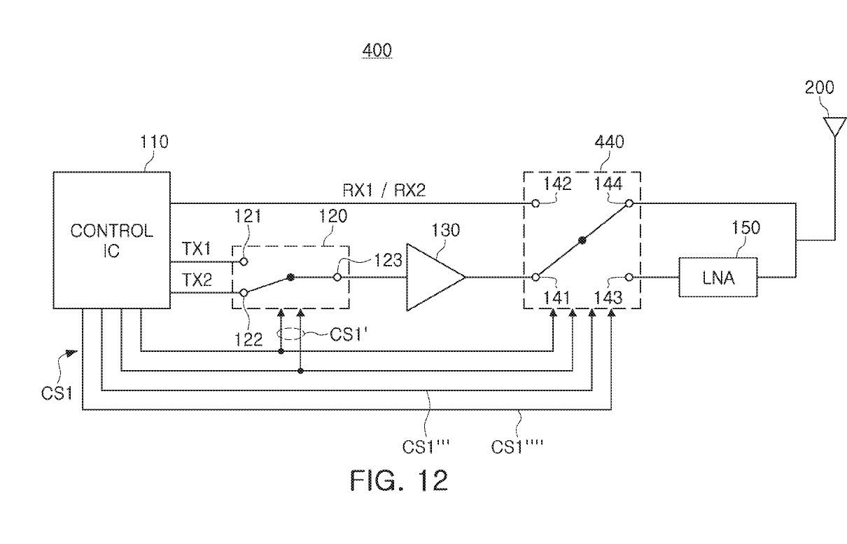

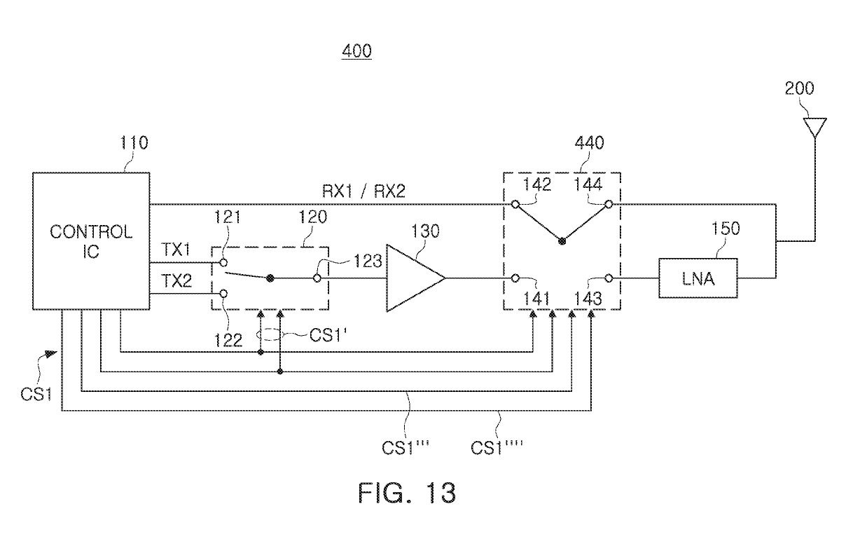

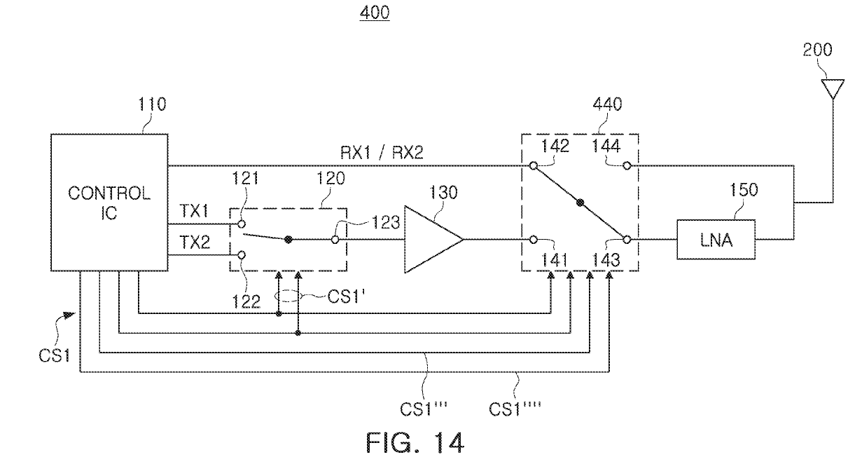

Also in an example of FIGS. 11 through 14, the front end module 400 may be operated by the control signal CS1 of Table 2. That is, FIG. 11 illustrates an example of a WL transmission mode, FIG. 12 illustrates an example of a BT transmission mode, FIG. 13 illustrates an example of a bypass reception mode, and FIG. 14 illustrates an example of a reception mode accompanied with amplification.

The second switch 440 may be a double-pole double-throw (DPDT) switch including the two first terminals 141 and 142 connected to the control integrated circuit 110 and the transmission amplifier 130, respectively, and two second terminals 143 and 144 connected to the reception amplifier 150 and the antenna 200, respectively.

In an embodiment, the second switch 440 is switched to connect the output terminal of the transmission amplifier 130 and the antenna 200 to each other when one of the first and second pulses CS1′ of the four pulses of the control signal CS1 is high.

In an embodiment, the second switch 440 is switched to connect the antenna 200 and the control integrated circuit 110 to each other when both of the first and second pulses CS1′ of the four pulses of the control signal CS1 are low and the third pulse CS1′″ of the four pulses of the control signal CS1 is high.

The second switch 440 is switched to directly connect the antenna 200 and the control integrated circuit 110 to each other when the fourth pulse CS1″″ is low. Meanwhile, the second switch 440 is switched to connect the reception amplifier 150 and the antenna 200 to each other when the fourth pulse CS″″ is high. Therefore, in this case, the control integrated circuit 110 receives the reception signals RX1 and RX2 amplified in the reception amplifier 150.

A switching operation of the first switch 120 may be understood through the foregoing description.

A wireless communications apparatus according to an embodiment may include a front end module described with reference to FIGS. 1 through 14. The front end module may be a separate component that may be coupled to the wireless communications apparatus, or may be one component configured integrally with the wireless communications apparatus and as a portion of the wireless communications apparatus. However, since other components of the wireless communications apparatus except for the front end module may be variously applied, they are not separately restrictively described.

As set forth above, according to the embodiments disclosed herein, a plurality of wireless communications standards may be supported by one amplifier.

The apparatuses, units, modules, devices, and other components (e.g., the control integrated circuit 110, switches 120, 140 and 440, transmission amplifier 130 and reception amplifier 150) described herein with respect to FIGS. 1-14 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A front end module comprising:
a control integrated circuit configured to output at least one of a first transmission signal according to a first wireless communications standard and a second transmission signal according to a second wireless communications standard;
a first switch configured to receive the at least one of the first transmission signal and the second transmission signal and output the first transmission signal or the second transmission signal in response to a control signal transmitted from the control integrated circuit; and
a transmission amplifier configured to amplify the first transmission signal or the second transmission signal output from the first switch.

2. The front end module of claim 1, further comprising a second switch configured to be switched, in response to the control signal, to connect an output terminal of the transmission amplifier and an antenna to each other or connect the antenna and the control integrated circuit to each other.

3. The front end module of claim 2, wherein:
the control integrated circuit is configured to output the control signal including a plurality of pulses; and
the first switch is configured to be switched in response to a portion of the plurality of pulses of the control signal.

4. The front end module of claim 2, further comprising a reception amplifier connected to the second switch and configured to amplify reception signals.

5. The front end module of claim 4, wherein:
the control integrated circuit is configured to output the control signal including four pulses; and
the first switch is configured to be switched in response to first and second pulses of the four pulses of the control signal.

6. The front end module of claim 5, wherein the second switch is configured to be switched in response to the four pulses of the control signal.

7. The front end module of claim 5, wherein the second switch is configured to be switched in response to first to third pulses of the four pulses of the control signal.

8. The front end module of claim 7, wherein the reception amplifier is configured to amplify the reception signals in response to a fourth pulse of the four pulses of the control signal.

9. The front end module of claim 5, wherein the second switch is configured to be switched to connect the output terminal of the transmission amplifier and the antenna to each other in response to one of the first and second pulses being high.

10. The front end module of claim 5, wherein the second switch is configured to be switched to connect the antenna and the control integrated circuit to each other in response to both of the first and second pulses being low and a third pulse of the four pulses of the control signal being high.

11. The front end module of claim 5, wherein the second switch is configured to be switched to connect the reception amplifier and the antenna to each other in response to both of the first and second pulses being low and a fourth pulse of the four pulses of the control signal being high.

12. The front end module of claim 4, wherein the second switch comprises a single-pole double-throw switch comprising two first terminals respectively connected to the control integrated circuit and the transmission amplifier, and one second terminal connected to the reception amplifier.

13. The front end module of claim 12, wherein the reception amplifier is configured to receive a portion of the control signal and amplify the reception signals in response to a portion of the control signals.

14. The front end module of claim 4, wherein the second switch comprises a double-pole double-throw switch comprising two first terminals respectively connected to the control integrated circuit and the transmission amplifier, and two second terminals respectively connected to the reception amplifier and the antenna.

15. The front end module of claim 14, wherein the reception amplifier is configured to amplify the reception signals when a path is formed by the second switch, without receiving the control signal.

16. The front end module of claim 1, wherein the first wireless communications standard is a Bluetooth scheme and the second wireless communications standard is a wireless local area network scheme.

17. A wireless communications apparatus comprising:
a front end module comprising:
a control integrated circuit configured to output at least one of a first transmission signal according to a first wireless communications standard and a second transmission signal according to a second wireless communications standard;
a first switch configured to receive the at least one of the first transmission signal and the second transmission signal and output the first transmission signal or the second transmission signal in response to a control signal transmitted from the control integrated circuit; and
a transmission amplifier configured to amplify the first transmission signal or the second transmission signal output from the first switch.

18. The wireless communications apparatus of claim 17, wherein the first wireless communications standard is a Bluetooth scheme and the second wireless communications standard is a wireless local area network scheme.
